(19) United States
(12) Patent Application Publication
(10) Pub. No.: US 2026/0104085 A1
(43) Pub. Date: Apr. 16, 2026

(54) DAMPING FORCE VARIABLE SHOCK ABSORBER

(71) Applicant: HL Mando Corporation, Pyeongtaek-si, Gyeonggi-do (KR)

(72) Inventor: Eunjoong KIM, Pyeongtaek-si (KR)

(21) Appl. No.: 19/274,900

(22) Filed: Jul. 21, 2025

(30) Foreign Application Priority Data
Oct. 16, 2024 (KR) 10-2024-0141091

(51) Int. Cl. F16F 9/516

(52) U.S. Cl. CPC F16F 9/516; F16F 2222/12; F16F 2230/18

(57) ABSTRACT

The present disclosure relates to a damping force variable shock absorber. The damping force variable shock absorber of the present disclosure includes a cylinder, a piston rod, a rod guide tube having an inner shell and an outer shell, and a damping force adjustment assembly having a mounting block coupled to the cylinder and a solenoid valve portion mounted on the mounting block, in which the mounting block has a guide flow path formed to guide the fluid so that fluid is transmitted from an outlet of any one of the plurality of solenoid valves to the inside of the cylinder without passing through another of the solenoid valves.

### CROSS-REFERENCE TO RELATED APPLICATION

This application claims the benefit of and priority to Korea Patent Application No. 10-2024-0141091, filed on Oct. 16, 2024, the entire disclosure(s) of which is hereby incorporated herein by reference in its entirety.

### TECHNICAL FIELD

The present disclosure relates to a damping force variable shock absorber, and more specifically, to a damping force variable shock absorber having a solenoid valve outside a cylinder.

### BACKGROUND

While a vehicle travels, the vehicle is constantly exposed to vibrations and shocks from a road surface through its wheels, and when the vibrations and shocks transmitted through the wheels are directly transmitted to a vehicle body and steering wheel, ride quality and driving stability are significantly reduced. In order to alleviate these vibrations and shocks, a vehicle should be equipped with a suspension device. Shock absorbers, springs, and suspension arms are the main components that constitute the suspension device.

The shock absorber includes a cylinder, a piston rod, a piston valve, or the like. The piston valve is located inside the cylinder in a state of being coupled to the piston rod to generate damping force.

When the damping force of the shock absorber is set to a weak level, it is possible to absorb vibration caused by uneven road surfaces and improve ride comfort. On the other hand, when the damping force is set to a high level, the body posture change is suppressed and steering stability is improved. Therefore, conventionally, it is common to select and apply a shock absorber with different damping force characteristics depending on the intended use of a vehicle.

Recently, a damping force variable shock absorber has been developed that can appropriately adjust the damping force characteristics of the shock absorber according to a road surface, traveling conditions, or the like by installing a damping force variable valve that can appropriately adjust the damping force characteristics of the shock absorber.

### SUMMARY

The present disclosure is intended to solve the above-mentioned problem and to provide a damping force variable shock absorber with small volume and low unit price.

According to one embodiment of the present disclosure, a damping force variable shock absorber includes: a cylinder; a piston rod reciprocating inside the cylinder; a rod guide tube disposed inside the cylinder, having an inner shell and an outer shell, and having at least a portion of the piston rod inserted into the rod guide tube; and a damping force adjustment assembly having a mounting block coupled to the cylinder, and a solenoid valve portion mounted on the mounting block and disposed outside the cylinder, in which the solenoid valve portion includes a plurality of solenoid valves, and the mounting block has a guide flow path formed to guide the fluid so that fluid is transmitted from an outlet of one of the plurality of solenoid valves to the inside of the cylinder without passing through another of the solenoid valves.

The solenoid valve portion may include a compression solenoid valve that selectively mutually connects a flow path inside the inner shell, and a flow path between the rod guide tube and the cylinder.

The solenoid valve portion may include a rebound solenoid valve that selectively mutually connects a flow path between the inner shell and the outer shell, and a flow path inside the inner shell.

The solenoid valve part may include a compression solenoid valve that selectively mutually connects a flow path inside the inner shell, and a flow path between the rod guide tube and the cylinder, and a fluid-communicating rebound solenoid valve that selectively mutually connects a flow path between the inner shell and the outer shell, and a flow path inside the inner shell.

The guide flow path may guide the fluid so that, during a compression stroke of the shock absorber, the fluid is transmitted from an outlet of one of the pluralities of solenoid valves to a flow path between the rod guide tube and the cylinder without passing through the another of the solenoid valves.

The guide flow path may guide the fluid so that, during a compression stroke of the shock absorber, the fluid is transmitted from an outlet of the compression solenoid valve to a flow path between the rod guide tube and the cylinder without passing through the another of the solenoid valves.

The solenoid valve portion may further include a fluid-communicating rebound solenoid valve that selectively mutually connects a flow path between the inner shell and the outer shell, and the flow path inside the inner shell, and the guide flow path may guide the fluid so that, during the compression stroke of the shock absorber, the fluid is transmitted from the outlet of the compression solenoid valve to the flow path between the rod guide tube and the cylinder without passing through the rebound solenoid valve.

The rebound solenoid valve may not include a rebound check valve for limiting the path of the fluid during the compression stroke of the shock absorber.

A distal end portion of the rebound solenoid valve may be disposed radially inside a central axis of the cylinder from the distal end portion of the compression solenoid valve.

An axial length of the rebound solenoid valve may be shorter than an axial length of the compression solenoid valve.

A proximal end of the rebound solenoid valve and a proximal end of the compression solenoid valve may be radially spaced apart from each other by the same distance from the central axis of the cylinder.

A connecting passage may be formed in the mounting block for interconnecting the one of the pluralities of solenoid valves and the another of the plurality of solenoid valves, and the connecting passage may be closer to the cylinder than the outlet.

The connecting passage and a proximal end portion of at least one of the solenoid valves may be radially spaced apart by the same distance from the cylinder.

The mounting block may include a first protrusion that protrudes horizontally from the cylinder by a first length, and a second protrusion that protrudes horizontally from the cylinder by a second length that is shorter than the first length, the compression solenoid valve may be coupled to the first protrusion, and the rebound solenoid valve may be coupled to the second protrusion.

The compression solenoid valve may include a compression check valve for limiting the path of the fluid during a tension stroke of the shock absorber.

The compression solenoid valve and the rebound solenoid valve may be disposed on a plane perpendicular to the central axis of the cylinder.

The compression solenoid valve and the rebound solenoid valve may be disposed in parallel with each other.

The compression solenoid valve and the rebound solenoid valve may be disposed in a plane perpendicular to a central axis of the cylinder, the compression solenoid valve and the rebound solenoid valve may be disposed in parallel with each other, a connecting passage may be formed in the mounting block to interconnect the compression solenoid valve and the rebound solenoid valve, and the connecting passage may be formed in the plane to be perpendicular to a disposition direction of the solenoid valve.

The distal end portion of the rebound solenoid valve may be disposed in the same plane as a distal end surface of the first protrusion.

A vehicle according to the present disclosure includes the damping force variable shock absorber according to the present disclosure.

### ADVANTAGEOUS EFFECTS

According to one embodiment of the present disclosure, a damping force variable shock absorber having a small volume and low unit cost is provided.

### BRIEF DESCRIPTION OF THE DRAWINGS

FIG. 1 is a view schematically illustrating an electronically controlled shock absorber with a dual solenoid valve is applied.

FIGS. 2 and 3 are views illustrating flow of a fluid during a compression stroke in the electronically controlled shock absorber with the dual solenoid valve is applied.

FIGS. 4 and 5 are views illustrating the flow of the fluid during a rebound stroke in the electronically controlled shock absorber with the dual solenoid valve is applied.

FIG. 6 is a perspective view of a damping force variable shock absorber according to one embodiment of the present disclosure.

FIG. 7 is a partial cutaway view of the damping force variable shock absorber according to one embodiment of the present disclosure.

### DETAILED DESCRIPTION

Embodiments of the present disclosure will be described in detail so that a person having ordinary skill in the art to which the present disclosure belongs can easily implement the present disclosure. The present disclosure can be implemented in various different forms and is not limited to the embodiments described herein.

It is noted that the drawings are schematic and not drawn to scale. The relative dimensions and proportions of parts in the drawings are exaggerated or reduced in size for clarity and convenience in the drawings, and any dimensions are for illustration only and are not limiting. Moreover, the same reference numerals are used for the same structure, element, or part illustrated in two or more drawings in order to indicate similar features.

The embodiments of the present disclosure specifically illustrate ideal embodiments of the present disclosure. As a result, various modifications of the diagrams are expected. Accordingly, the embodiments are not limited to a specific form of the illustrated area, but rather include modifications of the form by manufacturing, for example.

In addition, all technical and scientific terms used in the present specification, unless otherwise defined, have the meaning commonly understood by a person of ordinary skill in the art to which the present disclosure belongs. All terms used in the present specification have been selected for the purpose of more clearly describing the present disclosure and are not selected to limit the scope of rights under the present disclosure.

Additionally, expressions such as “including,” “comprising,” and “having,” as used herein, should be understood as open-ended terms that imply the possibility of including other embodiments, unless otherwise stated in the phrase or sentence in which the expression is included.

Additionally, the singular forms described herein may include plural meanings unless otherwise stated, and the same applies to the singular forms described in the claims.

In addition, expressions such as “first”, “second”, or the like used in the present specification are used to mutually distinguish multiple components, and do not limit the order or importance of the components.

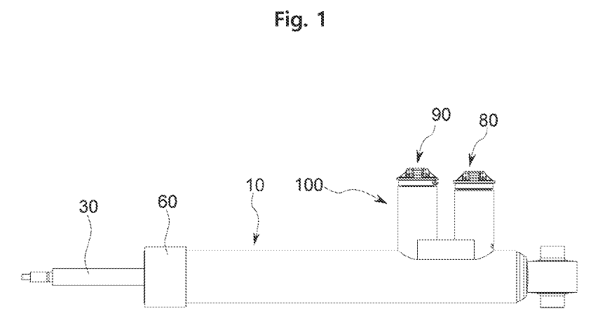

Hereinafter, with reference to FIGS. 1 to 5, the basic contents of a damping force variable shock absorber having a dual solenoid valve structure will be described.

As an example, referring to FIG. 1, a damping force variable shock absorber having a dual solenoid valve structure including a rebound solenoid valve 90 for adjusting a damping force during a rebound stroke and a compression solenoid valve 80 for adjusting a damping force during a compression stroke has been developed.

The interior of the cylinder constituting the shock absorber is divided into a compression chamber and a rebound chamber by the piston valve, and each chamber is filled with a fluid such as oil.

During the compression stroke, the piston valve pressurizes the fluid inside the compression chamber, so the compression chamber reaches a high pressure, and the rebound chamber reaches a relatively low pressure. During the rebound stroke, the piston valve pressurizes the fluid inside the rebound chamber, so the rebound chamber reaches a high pressure, and the compression chamber reaches a relatively low pressure.

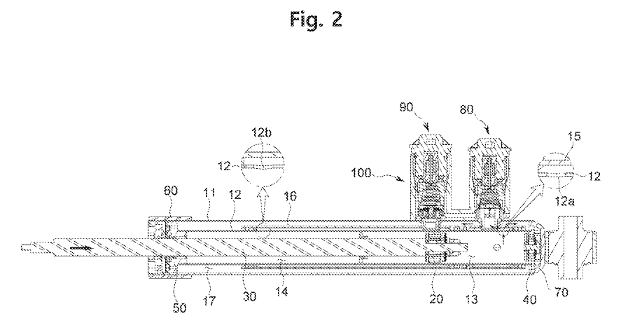

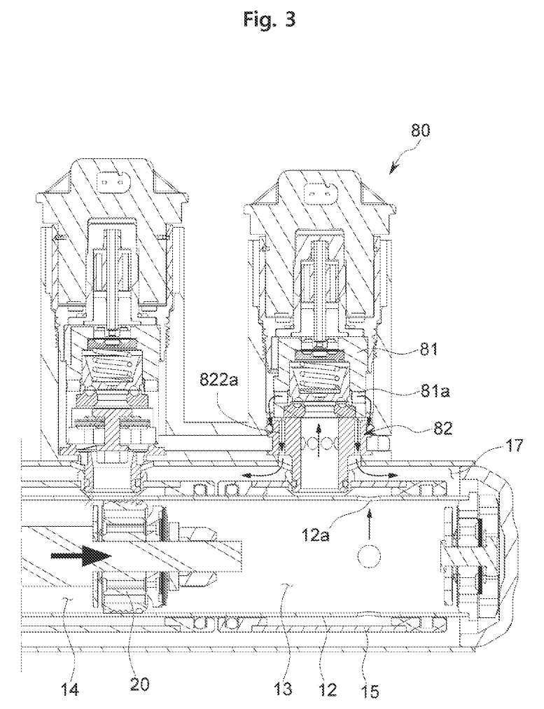

During a compression stroke of FIGS. 2 and 3, the fluid in the compression chamber 13 flows into a compression separation tube 15 and moves to a reservoir chamber 17 through the compression solenoid valve 80, and a portion of the fluid moves to the rebound chamber 14 through a bypass flow path of the piston valve.

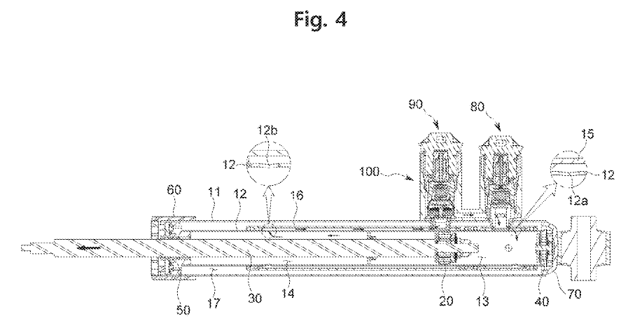

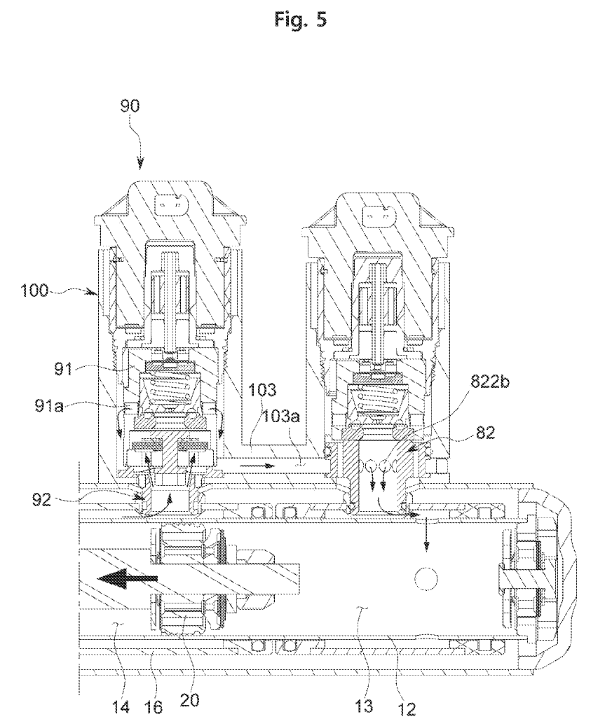

During the rebound stroke of FIGS. 4 and 5, the fluid in the rebound chamber 14 flows into a rebound separation tube 16 and moves into the compression chamber 13 through the compression solenoid valve 80 via the rebound solenoid valve 90 and a communication hole 103a of a connection portion 103, and a portion of the fluid moves into the compression chamber 13 through a bypass flow path of the piston valve.

A damping force variable shock absorber of the present disclosure includes a cylinder, a piston rod, a rod guide tube, and a damping force adjustment assembly. The piston rod reciprocates inside the cylinder. The rod guide tube is disposed inside the cylinder and has an inner shell and an outer shell, and at least a portion of the piston rod is inserted inside the rod guide tube. The damping force adjustment assembly has a mounting block coupled to the cylinder and a solenoid valve portion mounted on the mounting block and disposed outside the cylinder. The solenoid valve portion includes a plurality of solenoid valves. A guide flow path is formed in the mounting block to guide the fluid so that the fluid is transmitted from an outlet of one of the pluralities of solenoid valves to the inside of the cylinder without passing through another of the solenoid valves. According to the present disclosure, in order to transmit the fluid, which flows from one of the solenoid valves to another of the solenoid valves, to the cylinder side from the another of the solenoid valves, there is no need to install a check valve in the another of the solenoid valves. Therefore, the volume and cost of the shock absorber are reduced.

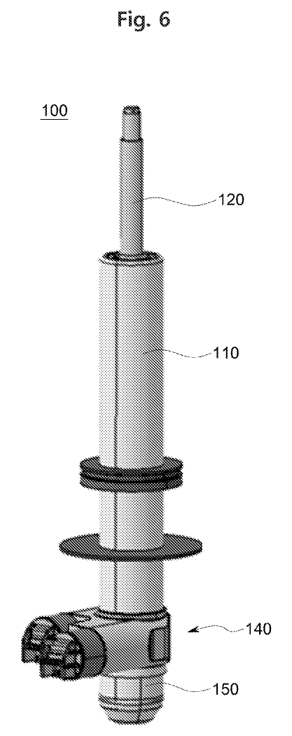

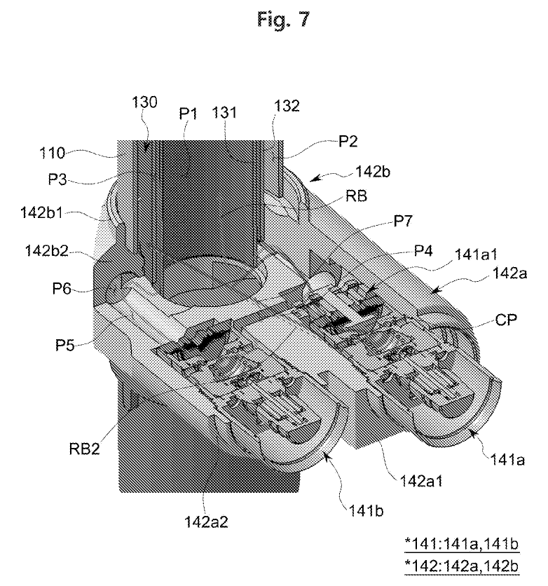

Hereinafter, a damping force variable shock absorber according to one embodiment of the present disclosure will be described with reference to the drawings. FIG. 6 is a perspective view of a damping force variable shock absorber according to one embodiment of the present disclosure. FIG. 7 is a partial cutaway view of a damping force variable shock absorber according to one embodiment of the present disclosure. Referring to FIGS. 6 and 7, a damping force variable shock absorber 100 according to one embodiment of the present disclosure includes a cylinder 110, a piston rod 120, a rod guide tube 130, a damping force adjustment assembly 140, a cap assembly 150, and a rod guide.

The piston rod 120 reciprocates inside the cylinder 110. The piston rod 120 can slide while being guided by the rod guide inside the cylinder 110. The rod guide can be arranged to guide a fluid inside a rebound chamber above the piston to the space between an inner shell 131 and an outer shell 132 to be described below.

The rod guide tube 130 is disposed inside the cylinder 110 and has the inner shell 131 and the outer shell 132. At least a part of the piston rod 120 is inserted into the rod guide tube. The rod guide can be coupled to the upper portion of the rod guide tube 130. A part of the rod guide protrudes outside the rod guide tube 130 and is supported by the upper surface of the rod guide tube 130, and another part of the rod guide can be inserted into the inside of the rod guide. A fluid (hereinafter, referred to as a “fluid”) of the shock absorber 100 can flow in the space between the inner shell 131 and the outer shell 132. An internal space of the inner shell 131 may be divided into a compression chamber and a rebound chamber by a piston mounted on the piston rod 120.

The damping force adjustment assembly 140 has a mounting block 142 coupled to a cylinder block and a solenoid valve portion 141 mounted on the mounting block 142 and positioned on the outside of the cylinder 110. A flow path communicating with the solenoid valve portion 141 and the flow path inside the cylinder 110 may be formed in the mounting block 142.

The mounting block 142 may include a support block 142a and a coupling portion 142b. The support block 142a supports the solenoid valve portion 141 and has a transmission flow path P5 connected to the solenoid valve portion 141. The coupling portion 142b is provided integrally with the support block 142a, is coupled to the cylinder 110, and has a flow path P3 between the inner shell 131 and the outer shell 132 and an internal cavity P6 connected to the flow path P1 inside the inner shell. The transmission flow path P5 and the internal cavity P6 are connected to each other.

The coupling portion 142b may include a flange portion 142b1 in surface contact with at least a portion of an outer peripheral surface of the cylinder 110. The flange portion 142b1 may prevent fluid from leaking between the cylinder 110 and the mounting block 142. The coupling portion 142b may include an inlet portion 142b2 that defines a flow path between the outer shell 132 and the inner shell 131. The lower end portion of at least one of the cylinder 110 and the rod guide tube 130 may be supported upward by the inlet portion 142b2. At least a portion of the internal cavity may extend in a radial direction of the cylinder 110. At least a portion of the transmission flow path may extend in a direction perpendicular to the central axis of the cylinder 110. The coupling portion 142b may have a ring shape that shares a central axis with the cylinder 110.

The solenoid valve portion 141 includes a plurality of solenoid valves 141a and 141b. The solenoid valve portion 141 may include a compression solenoid valve 141a that selectively mutually connects the flow path P1 inside the inner shell 131 and a flow path P2 between the rod guide tube 130 and the cylinder 110. The compression solenoid valve 141a may be configured to selectively mutually connect the compression chamber and the flow path P2 between the rod guide tube 130 and the cylinder 110.

The compression solenoid valve 141a may include a compression check valve 141a1 that allows the flow of fluid from the flow path P1 inside the inner shell 131 to the flow path P2 between the rod guide tube 130 and the cylinder 110, and restricts the flow of fluid from the flow path P2 between the rod guide tube 130 and the cylinder 110 to the flow path P1 inside the inner shell 131.

The solenoid valve portion 141 may include a rebound solenoid valve 141b that selectively mutually connects the flow path P3 between the inner shell 131 and the outer shell 132, and the flow path P1 inside the inner shell. The rebound solenoid valve 141b may selectively mutually connect the flow path P3 between the inner shell 131 and the outer shell 132, and the compression chamber.

The rebound solenoid valve 141b may not include a rebound check valve for limiting the path of the fluid during the compression stroke of the shock absorber 100. This reduces the volume and cost of the shock absorber 100.

In one embodiment, the solenoid valve portion includes a compression solenoid valve and a rebound solenoid valve.

The mounting block may include a guide flow path P7 for guiding the fluid so that the fluid is transmitted from an outlet of one 141a of the plurality of solenoid valves 141a and 141b to the interior of the cylinder 110 without passing through another 141b of the solenoid valves. The guide flow path P7 may guide the fluid so that, during a compression stroke of the shock absorber 100, the fluid is transmitted from an outlet of the one 141a of the plurality of solenoid valves 141a and 141b to the flow path P2 between the rod guide tube 130 and the cylinder 110 without passing through the another 141b of the solenoid valves. In one embodiment, the guide flow path P7 guides the fluid so that, during the compression stroke of the shock absorber 100, the fluid is transmitted from the outlet of the compression solenoid valve 141a to the flow path P2 between the rod guide tube 130 and the cylinder 110 without passing through the rebound solenoid valve 141b. At least a portion of the guide flow path P7 may be formed inside the mounting block 142. At least a portion of the guide flow path P7 may be a cavity surrounded by the mounting block 142.

The mounting block 142 may include a first protrusion 142a1 that protrudes horizontally from the cylinder by a first length, and a second protrusion 142a2 that protrudes horizontally from the cylinder by a second length. Here, the second length is shorter than the first length. The compression solenoid valve 141a may be coupled to the first protrusion 142a1, and the rebound solenoid valve 141b may be coupled to the second protrusion 142a2. At least a portion of the compression solenoid valve 141a may be inserted into a first mounting hole formed to be recessed from an end surface of the first protrusion 142a1, and at least a portion of the rebound solenoid valve 141b may be inserted into a second mounting hole formed to be recessed from an end surface of the second protrusion 142a2. The distal end portion of the rebound solenoid valve 141b may be disposed on the same plane as the distal end surface of the first protrusion 142a1.

The compression solenoid valve 141a and the rebound solenoid valve 141b may be disposed on a plane perpendicular to a central axis C of the cylinder 110. The compression solenoid valve 141a and the rebound solenoid valve 141b may be disposed parallel to each other. The compression solenoid valve 141a and the rebound solenoid valve 141b may be disposed on the same plane as each other.

In one embodiment, a connecting passage P4 that interconnects the compression solenoid valve 141a and the rebound solenoid valve 141b may be formed in the mounting block 142. The connecting passage P4 may be formed perpendicular to the disposition direction of the solenoid valve 141 on the plane.

The distal end portion of the rebound solenoid valve 141b may be positioned radially inside a central axis of the cylinder from the distal end portion of the compression solenoid valve 141a. An axial length of the rebound solenoid valve 141b may be shorter than an axial length of the compression solenoid valve 141a. Here, the axial direction refers to the central axis of each solenoid valve. The proximal end portion of the rebound solenoid valve 141b and the proximal end portion of the compression solenoid valve 141a may be spaced apart from each other by the same distance in the radial direction from the central axis of the cylinder 110. A cylinder 110-side end surface of the rebound solenoid valve 141b and a cylinder 110-side end surface of the compression solenoid valve 141a may be positioned on the same plane.

The connecting passage P4 may be closer to the cylinder 110 than the outlet of one 141a of the plurality of solenoid valves. The connecting passage P4 and the proximal end portion of at least one solenoid valve 140 may be radially spaced apart by the same distance from the cylinder 110.

The cap assembly 150 is coupled to the damping force adjustment assembly 140 to divide the interior of the shock absorber 100. In one embodiment, the cylinder 110 is mounted on the upper side of the damping force adjustment assembly 140, and the cap assembly 150 is mounted on the lower side of the damping force adjustment assembly 140. At least a portion of the mounting block 142 can be in surface contact with the outer peripheral surface of the cap assembly 150.

Referring to CP of FIG. 7, during the compression stroke, the fluid may sequentially pass through the “inside (P1, specifically, the compression chamber) of the inner shell 131”, the “internal cavity P6”, the “transfer flow path P5”, the “compression solenoid valve 141a”, and the “guide flow path P7”, and flow into the “space P2 between the cylinder 110 and the rod guide tube 130”.

Referring to RB and RB2 of FIG. 7, during the rebound stroke, the fluid may sequentially pass through the “inside (P1, specifically, the rebound chamber) of the inner shell 131”, the “space P3 between the inner shell 131 and the outer shell 132”, the “internal cavity P6”, the “transmission flow path P5”, the “rebound solenoid valve 141b”, and the “connecting passage P4”, and flow into the compression chamber (path RB). A portion of the fluid flowing into the “space P3 between the inner shell 131 and the outer shell 132” may also flow into the compression chamber through the guide flow path P4 and the compression solenoid valve 141a.

In the present disclosure, it may be understood that the space below the piston within the inner shell 131 corresponds to the “compression chamber”, the space above the piston within the inner shell 131 corresponds to the “rebound chamber”, the space P3 between the inner shell 131 and the outer shell 132 corresponds to a “separation flow path”, and the space P2 between the rod guide tube 130 and the cylinder 110 corresponds to a “reservoir chamber”.

The vehicle of the present disclosure includes a damping force variable shock absorber of the present disclosure.

The above description is only an example of the technical idea of the present disclosure, and those skilled in the art to which the present disclosure belongs can make various modifications, changes, and substitutions without departing from the essential characteristics of the present disclosure. Therefore, the present embodiments are not intended to limit the technical idea of the present disclosure, but to explain it, and the scope of the technical idea of the present disclosure is not limited by these embodiments. The protection scope of the present disclosure should be interpreted by the claims below, and all technical ideas within a scope equivalent thereto should be interpreted as being included in the scope of the rights of the present disclosure.

### Detailed Description of Main Elements

100: damping force variable shock absorber

110: cylinder

120: piston rod

130: rod guide tube

131: inner shell

132: outer shell

140: damping force adjustment assembly

141: solenoid valve portion

142: mounting block

P4: guide flow path

What is claimed is:

1. A damping force variable shock absorber, comprising:
a cylinder;
a piston rod reciprocating inside the cylinder;
a rod guide tube disposed inside the cylinder, and having an inner shell and an outer shell, wherein at least a portion of the piston rod is inserted into the rod guide tube; and
a damping force adjustment assembly having a mounting block coupled to the cylinder, and a solenoid valve portion mounted on the mounting block and disposed outside the cylinder,
wherein the solenoid valve portion includes a plurality of solenoid valves, and
the mounting block has a guide flow path configured to guide a fluid so that the fluid is transmitted from an outlet of one solenoid valve of the plurality of solenoid valves to an inside of the cylinder without passing through another solenoid valve of the plurality of solenoid valves.

2. The damping force variable shock absorber of claim 1, wherein the plurality of solenoid valves includes a compression solenoid valve configured to selectively mutually connect a flow path inside the inner shell, and a flow path between the rod guide tube and the cylinder.

3. The damping force variable shock absorber of claim 1, wherein the plurality of solenoid valves includes a rebound solenoid valve configured to selectively mutually connect a flow path between the inner shell and the outer shell, and a flow path inside the inner shell.

4. The damping force variable shock absorber of claim 1, wherein the plurality of solenoid valves includes:
a compression solenoid valve configured to selectively mutually connect a flow path inside the inner shell, and a flow path between the rod guide tube and the cylinder, and
a fluid-communicating rebound solenoid valve configured to selectively mutually connect a flow path between the inner shell and the outer shell, and the flow path inside the inner shell.

5. The damping force variable shock absorber of claim 1, wherein the guide flow path is configured to guide the fluid so that, during a compression stroke of the shock absorber, the fluid is transmitted from the outlet of the one solenoid valve to a flow path between the rod guide tube and the cylinder without passing through the another solenoid valve.

6. The damping force variable shock absorber of claim 1, wherein
the one solenoid valve is a compression solenoid valve configured to selectively mutually connect a flow path inside the inner shell, and a flow path between the rod guide tube and the cylinder, and
the guide flow path is configured to guide the fluid so that, during a compression stroke of the shock absorber, the fluid is transmitted from the outlet of the compression solenoid valve to the flow path between the rod guide tube and the cylinder without passing through the another solenoid valve.

7. The damping force variable shock absorber of claim 6, wherein
the another solenoid valve is a fluid-communicating rebound solenoid valve configured to selectively mutually connect a flow path between the inner shell and the outer shell, and the flow path inside the inner shell, and
the guide flow path is configured to guide the fluid so that, during the compression stroke of the shock absorber, the fluid is transmitted from the outlet of the compression solenoid valve to the flow path between the rod guide tube and the cylinder without passing through the rebound solenoid valve.

8. The damping force variable shock absorber of claim 7, wherein the rebound solenoid valve does not include a rebound check valve for limiting a flow of the fluid through the rebound solenoid valve during the compression stroke of the shock absorber.

9. The damping force variable shock absorber of claim 8, wherein a distal end portion of the rebound solenoid valve is disposed radially closer to a central axis of the cylinder than a distal end portion of the compression solenoid valve.

10. The damping force variable shock absorber of claim 9, wherein an axial length of the rebound solenoid valve is shorter than an axial length of the compression solenoid valve.

11. The damping force variable shock absorber of claim 10, wherein a proximal end of the rebound solenoid valve and a proximal end of the compression solenoid valve are radially spaced apart by the same distance from the central axis of the cylinder.

12. The damping force variable shock absorber of claim 1, wherein
the mounting block includes a connecting passage interconnecting the one solenoid valve and the another solenoid valve, and
the connecting passage is closer to the cylinder than the outlet of the one solenoid valve.

13. The damping force variable shock absorber of claim 12, wherein the connecting passage and a proximal end portion of at least one of the plurality of solenoid valves are radially spaced apart by the same distance from the central axis of the cylinder.

14. The damping force variable shock absorber of claim 10, wherein
the mounting block includes:
a first protrusion that protrudes horizontally from the cylinder by a first length, and
a second protrusion that protrudes horizontally from the cylinder by a second length that is shorter than the first length,
the compression solenoid valve is coupled to the first protrusion, and
the rebound solenoid valve is coupled to the second protrusion.

15. The damping force variable shock absorber of claim 7, wherein the compression solenoid valve includes a compression check valve for limiting a flow of the fluid through the compression solenoid valve during a rebound stroke of the shock absorber.

16. The damping force variable shock absorber of claim 7, wherein the compression solenoid valve and the rebound solenoid valve are disposed on a plane perpendicular to a central axis of the cylinder.

17. The damping force variable shock absorber of claim 7, wherein the compression solenoid valve and the rebound solenoid valve are disposed in parallel with each other.

18. The damping force variable shock absorber of claim 7, wherein
the compression solenoid valve and the rebound solenoid valve are disposed in a plane perpendicular to a central axis of the cylinder,
the compression solenoid valve and the rebound solenoid valve are disposed in parallel with each other in a disposition direction,
the mounting block includes a connecting passage interconnecting the compression solenoid valve and the rebound solenoid valve, and
the connecting passage is formed in the plane to be perpendicular to the disposition direction of the compression solenoid valve and the rebound solenoid valve.

19. The damping force variable shock absorber of claim 14, wherein the distal end portion of the rebound solenoid valve is disposed in the same plane as a distal end surface of the first protrusion.

20. A vehicle, comprising a damping force variable shock absorber which comprises:
a cylinder;
a piston rod reciprocating inside the cylinder;
a rod guide tube disposed inside the cylinder, and having an inner shell and an outer shell, wherein at least a portion of the piston rod is inserted into the rod guide tube; and
a damping force adjustment assembly having a mounting block coupled to the cylinder, and a solenoid valve portion mounted on the mounting block and disposed outside the cylinder,
wherein the solenoid valve portion includes a plurality of solenoid valves, and
the mounting block has a guide flow path configured to guide a fluid so that the fluid is transmitted from an outlet of one solenoid valve of the plurality of solenoid valves to an inside of the cylinder without passing through another solenoid valve of the plurality of solenoid valves.
